(19) United States
(12) Patent Application Publication
(10) Pub. No.: US 2019/0047499 A1
(43) Pub. Date: Feb. 14, 2019

(54) Car Door Protector

(71) Applicants: Javier Villegas, Bay City, TX (US); Eduardo Morales, Hormigueros, PR (US)

(72) Inventors: Javier Villegas, Bay City, TX (US); Eduardo Morales, Hormigueros, PR (US)

(21) Appl. No.: 15/984,525

(22) Filed: May 21, 2018

Related U.S. Application Data
(60) Provisional application No. 62/542,998, filed on Aug. 9, 2017.

(51) Int. Cl. B60R 19/42; B60R 19/38

(52) U.S. Cl. CPC B60R 19/42; B60R 19/38

(57) ABSTRACT

A tool for protecting car doors. The car door protector includes a telescoping rod that expands and retracts, with a fastener disposed on a first end and a second end in order to secure the car door protector to a car. A magnet is placed within each fastener. A cord is attached to the telescoping rod, wherein the cord includes a weighted anchor attached to an end thereof. In operation, a user attaches one of the fasteners and magnets to a car door. The cord can be passed through an open window such that the anchor is in the interior of the vehicle. The window can then be closed, wherein the anchor prevents the cord from being removed. The second end of the telescoping rod is then removably secured a second car door, thereby protecting one side of a car.

### CROSS REFERENCE TO RELATED APPLICATIONS

This application claims the benefit of U.S. Provisional Application No. 62/542,998 filed on Aug. 9, 2017. The above identified patent application is herein incorporated by reference in its entirety to provide continuity of disclosure.

### BACKGROUND OF THE INVENTION

The present invention relates to car door protector devices. More specifically, the present invention provides a telescopic rod having fasteners disposed at each end, wherein magnets are disposed within the fasteners. The fasteners are configured to affix to a car door. A cord is affixed to the telescopic rod, wherein a weight is pivotally affixed to the distal end of the cord, thereby providing stability to the telescopic rod.

Car doors are often subject to damage, whether accidental or intentional. Often, individuals become distracted when parking and getting out of their vehicles, opening their respective car doors quickly, thereby striking a nearby car door. Additionally, during inclement weather, wind may push a car door open, forcing it to move faster than expected and accidentally impacting the door of a neighboring car. As a result of such damage, many people hire professional mechanics to fix or repaint the damage done to their car. Thus, an improved car door protector is desired for allowing a person to easily protect their car doors while away from their cars.

Devices have been disclosed in the known art that relate to car door protector devices. These include devices that have been patented and published in patent application publications. These devices generally relate to bars or pads that affix to the sides of car doors to prevent dents from other cars. These known art devices have several known drawbacks. These devices fail to disclose a telescoping rod with magnetic fasteners at each end and a cable affixed to the rod wherein the other end of the cable has an object affixed thereto.

In light of the devices disclosed in the known art, it is submitted that the present invention substantially diverges in design elements from the known art and consequently it is clear that there is a need in the art for an improvement to existing car door protection devices. In this regard the instant invention substantially fulfills these needs.

### SUMMARY OF THE INVENTION

In view of the foregoing disadvantages inherent in the known types of car door protection devices now present in the prior art, the present invention provides a new car door protector wherein the same can be utilized for providing convenience for the user when affixing a bar to their vehicle door to protect it from damage.

It is therefore an object of the present invention to provide a new and improved car door protector device that has all of the advantages of the known art and none of the disadvantages. The car door protector comprises a telescoping rod that expands and retracts, wherein a fastener is disposed on a first end and a second end. A magnet is disposed within each fastener. A cord is affixed to the telescoping rod, wherein the cord comprises a weighted anchor affixed to an end thereof. In operation, a user affixes one of the fasteners and magnets to a car door. The cord is configured to be passed over an open window when the anchor is in the interior of the vehicle. The window can then be closed, wherein the anchor prevents the cord from being removed. The second end of the telescoping rod is then removably secured a second car door, thereby protecting one side of a car.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an extended form of the car door protector.

FIG. 2 shows a perspective view of a retracted form of the car door protector.

FIG. 3 shows a side view of the car door protector extended and in use.

FIG. 4 shows a perspective view of an alternative embodiment of the weighted anchor of the car door protector in use.

### DETAILED DESCRIPTION OF THE INVENTION

Reference is made herein to the attached drawings. Like reference numerals are used throughout the drawings to depict like or similar elements of the telescopic rod. The figures are intended for representative purposes only and should not be considered to be limiting in any respect.

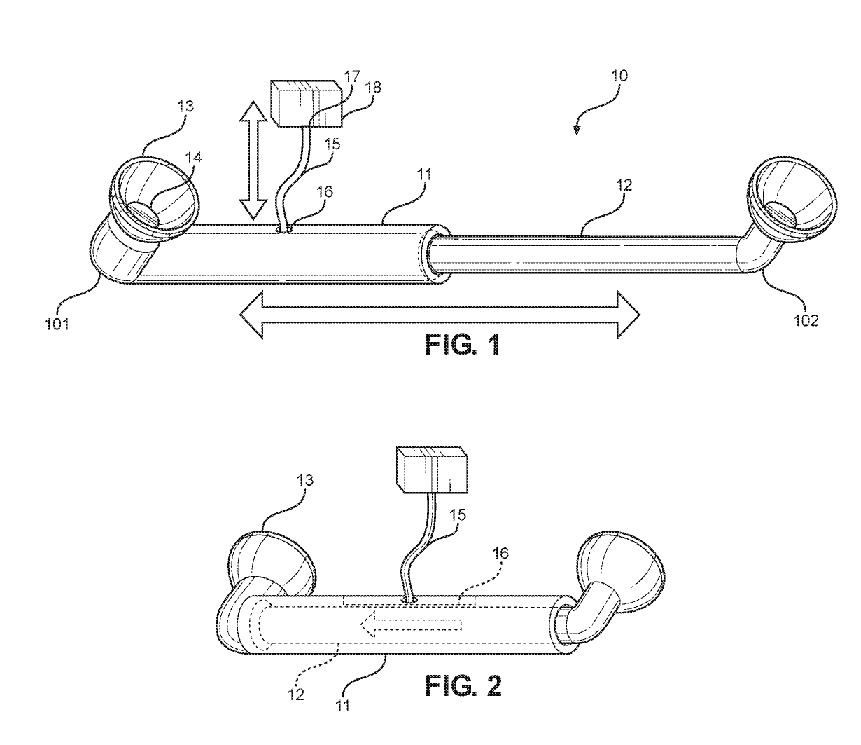

Referring now to FIG. 1 and FIG. 2, there are shown perspective views of an embodiment of the car door protector in an extended form and a retracted form, respectively, while unattached to a vehicle. A car door protector comprises a telescopic rod 10 having a housing 11 and a retractable portion 12, wherein the retractable portion 12 is insertable into the housing 11. The telescopic rod 10 comprises a first end 101 and second end 102, wherein a fastener 13 is disposed on each end 101, 102 of the telescopic rod 10 and configured to removably secure each end of the telescopic rod 10 to a vehicle. In the illustrated embodiment, each fastener 13 is disposed at an outermost end of the telescopic rod 10. The fastener 13 is a suction cup in the illustrated embodiment. In this way, individuals may quickly and easily removably secure the telescopic rod 10 to a vehicle. However, in other embodiments, the fastener 13 can be any suitable fastener configured to removably affix to the vehicle and not cause damage thereto, such as removable adhesive. The telescopic rod 10 is in a retracted position when the retractable portion 12 is inserted into the housing 11 such that only the fastener 13 disposed on the outermost end 102 is visible.

In the illustrated embodiment, a magnet 14 is disposed within the fastener 13, such that the telescopic rod 10 is configured to removably secure to a vehicle. In the illustrated embodiment, the magnet 14 is disposed about the center of the fastener 13. Additionally, in the illustrated embodiment, the magnet 14 is configured such that it is no larger than the fastener 13 itself. In other embodiments a plurality of magnets 14 are utilized and can be disposed about the fastener 13 in such a way that is configured to removably secure to the vehicle.

In the illustrated embodiment, a cord 15 is affixed to the housing 11 of the telescopic rod 10, wherein the cord 15 comprises a weighted anchor 18 pivotally affixed to an opposing distal end of the cord 15 via an anchor fastener 17. In the shown embodiment, the anchor fastener 17 comprises a swivel, however in other embodiments the anchor fastener 17 can be any suitable fastener configured to pivot. In alternative embodiments, the cord 15 is disposed about a circumference of the weighted anchor 18, such that the cord 15 comprises the anchor fastener 17. In one embodiment, the weighted anchor 18 is configured to weigh 2 pounds, however in other embodiments, the weighted anchor 18 is sized relative to a size of a vehicle such that a larger vehicle requires a heavier anchor and is configured to weigh greater than 2 pounds. In the shown embodiment, the weighted anchor 18 is configured as a solid rectangular prism. In additional embodiments, the weighted anchor 18 comprises a solid cylinder, a solid sphere, an open circle, or any other suitable geometric shape. In the illustrated embodiment, the cord 15 is configured to retract into the housing 11, wherein the cord 15 is stored in a cord housing component 16 positioned inside the housing 11. Additionally, in the exemplary embodiment, the housing 11 is configured to accommodate the cord housing component 16 without impeding the insertion of the retractable portion 12 when the telescopic rod 10 is in the retracted position. In the shown embodiment, the telescopic rod 10 is composed of metal, such that it provides a robust protection from any potential impacts. In alternate embodiments, the telescopic rod 10 can be composed of plastic or wood or any suitably durable material.

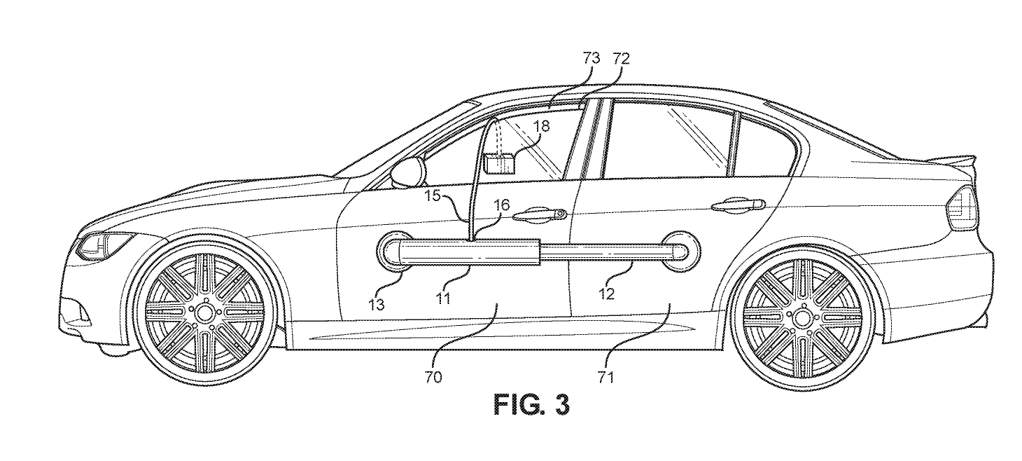

Referring now to FIG. 3, there is shown a side view of an embodiment of the car door protector extended and in use. The telescopic rod 10 is configured to be affixed to a front door 70 of a vehicle through the fastener 13. In use, the cord 15 is guided through an opening 73 of a window 72, wherein the weighted anchor 18 rests inside the vehicle. In this way, the weighted anchor 18 prevents movement of the telescopic rod 10 should the fastener 13 become dislodged. The weighted anchor 18 is configured to prevent the removal of the telescopic rod 10 from the door of the vehicle 70 through environmental damage such as wind, accidental damage such as a car door from a second vehicle, or attempted theft of the car door protector. In the extended position, the retractable portion 12 is configured to be affixed to a back door 71 of the vehicle through the fastener 13, wherein the back door 71 is proximal to the front door 70. In such a way, the car door protector is adapted to be removably secured to a side of the vehicle, such that both doors 70 and 71 of the vehicle are protected from damage.

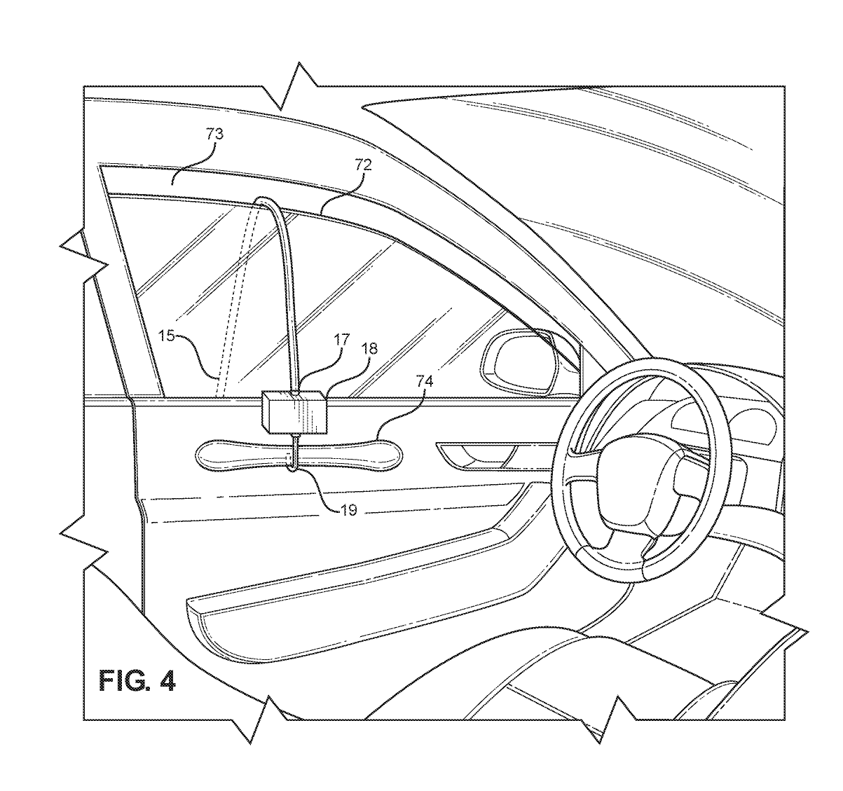

Referring now to FIG. 4, there is shown a perspective view of an alternative embodiment of the weighted anchor of the car door protector in use. In an alternative embodiment, the weighted anchor 18 comprises a secondary fastener 19 disposed on a side thereof opposite the cord 15. In the illustrated embodiment, the secondary fastener 19 comprises a hook, although in alternate embodiments a magnet or other suitable fastener is used. In use, the cord 15 is conducted through an opening 73 in the window 72 and configured such that the secondary fastener 19 is removably secured to an inner section of the vehicle 74, such as an interior door handle. In this way, an individual may easily and securely affix the weighted anchor 18 to the inner section of the vehicle 74 such that the weighted anchor 18 is steadied, thereby preventing potential damage to the window 72 and allowing for additional stability of the telescopic rod 10.

In operation the car door protector removably secures to an outer surface of a car door. The telescopic rod is retracted, and the first end is positioned against the side of a vehicle, such that the fastener and magnet disposed in the first end removably secure to the front door of the vehicle. The cord is affixed to the telescopic rod, wherein the weighted anchor is affixed to the distal end of the cord. The weighted anchor and cord are guided through an opening in the window and used to further secure the telescopic rod to the vehicle should the fasteners on either end become detached. The telescopic rod is extended and the second end is positioned against the side of the vehicle, such that the fastener and magnet disposed in the second end removably secure to the back door of the vehicle, and the telescopic rod is extended across one side of the vehicle. The telescopic rod is configured to absorb and disperse a compact impact across a wide area, thereby negating any potential damage imposed on the vehicle.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

Therefore, the foregoing is considered as illustrative only of the principles of the invention. Further since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A car door protector, comprising:
a telescopic rod, having a first end and a second end, wherein the telescopic rod comprises a housing portion and a retractable portion;
a fastener disposed on each of the first and second end of the telescopic rod, configured to removably secure the telescopic rod to a vehicle;
a magnet disposed within the fastener, configured to removably secure the telescopic rod to a vehicle;
a cord affixed to the housing of telescopic rod, wherein the cord comprises a weighted anchor pivotally affixed to an opposing distal end of the cord;
wherein the telescopic rod can move between an extended position and a retracted position, wherein the distance between the first and second ends of the rod is greater in the extended position than in the retracted position.

2) The telescopic rod of claim 1, wherein the magnet is disposed about the center of the fastener.

3) The telescopic rod of claim 1, wherein the magnet comprises a circle cross section configured no larger than the fastener.

4) The telescopic rod of claim 1, wherein the fastener comprises a suction cup.

5) The telescopic rod of claim 1, wherein the retractable portion is fully inserted in the housing in the retracted position, such that only the fastener affixed to the retracted portion extends from the housing.

6) The telescopic rod of claim 1, wherein the cord is configured to retract into a housing of the telescopic rod.

7) The telescopic rod of claim 5, wherein a cord housing is positioned in the housing of the telescopic rod such that it does not impede the movement of the telescopic rod between the extended position and the retracted position.

8) The telescopic rod of claim 1, wherein the weighted anchor is configured as a three-dimensional solid rectangle.

9) The telescopic rod of claim 1, wherein a secondary fastener is disposed on an opposing distal end of the weighted anchor adapted to affix the anchor to an interior portion of a vehicle.

10) The telescopic rod of claim 9, wherein the secondary fastener comprises a hook.

11) A method for protecting two car doors, comprising:
fastening a first end of a telescopic rod via a fastener to an exterior of a first car door of a vehicle, wherein the telescopic rod includes a magnet disposed within the fastener, wherein the fasteners positioned on each of a first and a second end of the telescopic rod;
extending a cord from the telescopic rod, wherein the cord is retractably affixed to the telescopic rod;
positioning a distal end of the cord through an opening of the vehicle, wherein the distal end includes a weighted anchor pivotally affixed thereto;
fastening the second end of a telescopic rod via a fastener to an exterior of a second car door of a vehicle, wherein the second car door is proximal to the first car door.

12) The method of claim 11, further comprising:
securing a secondary fastener to an interior door, wherein the secondary fastener is directly affixed to the weighted anchor.
